(19) United States
(12) Patent Application Publication
(10) Pub. No.: US 2007/0092686 A1
(43) Pub. Date: Apr. 26, 2007

(54) CATCH TRAY

(76) Inventor: Danny D. Fields, Stanley, NC (US)

Correspondence Address: HAMMER & HANF, P.C.;Suite G, 3125 Springbank Lane, Charlotte, NC, 28226, US

(21) Appl. No.: 11/552,566

(22) Filed: Oct. 25, 2006

Related U.S. Application Data
(60) Provisional application No. 60/729,939, filed on Oct. 25, 2005.

(51) Int. Cl. B32B 3/02

(52) U.S. Cl. 428/68; 428/138

(57) ABSTRACT

A disposable device configured to bind unwanted fluids is taught. The disposable device is comprised of a basin which holds a first layer and a second absorbent layer, enclosed by a perforated sheet. The basin has a base and at least one upwardly emanating side. The perforated sheet is attached to the side. The first layer can be an absorbent material, an adhesive material or a combination thereof. Both the perforated sheet and the basin can be made of a rigid or semi-rigid material. The disposable device is configured to be discarded once the absorbent material is saturated.

### RELATED CASES

This application claims the Priority of the Provisional Application Ser. No. 60/729,939 filed Oct. 25, 2005.

### FIELD OF THE INVENTION

The present invention relates generally to disposable devices designed to bind unwanted fluids and more specifically, unwanted dripping fluids from a motor vehicle.

### BACKGROUND OF THE INVENTION

As a machine or vehicle operates its parts become worn, gaskets shrink, metal fatigues and eventually leaks develop. As motor fluids leak from an engine onto a floor, they pose a significant slip danger to persons walking through. Additionally, the fluids are tracked across the floor, into homes and into vehicles as people walk across the soiled area. Dripping motor fluids can be difficult and time consuming to clean up.

People attempt to solve this problem by using absorbent materials in the form of mats and pads. The pads are placed under the vehicle or machine alone or within a mat or tray. After the pads become saturated with fluids, the pads must be disposed of and the tray must be cleaned out prior to returning them to their desired position. Disposal of the pads and cleaning of the trays is often a laborious, messy and unpleasant task resulting in a loss of time, soiling of hands and clothing and a loss of productivity. Additionally, if the trays and pads are not disposed of carefully, the retained fluids may be transferred back to the floor they were meant to protect.

U.S. Pat. No. 3,141,522 to Fitzpatrick provides for a disposable oil absorbing mat with an envelope-like opening which may be reused or discarded when it becomes saturated with oil; however, this system leads to potential mat cleaning and manual transfer of a saturated material for disposal opening up the potential for soiling of clothing, flooring and skin.

U.S. Pat. No. 5,020,638 to Smith describes a reusable tray system with a disposable pad and bag attachment; however this system leads to potential tray cleaning and manual transfer of the saturated pad into the bag for disposal opening up the potential for soiling of clothing, flooring and skin.

U.S. Pat. Nos. 4,798,754; 6,899,940 and 5,957,241 to Tomek, Leriget and Anderson respectively teach the use of reusable absorbent floor mats; however, each respective system leads to potential mat cleaning and manual transfer of a saturated pad for disposal opening up the potential for soiling of clothing, flooring and skin.

U.S. Pat. No. 5,928,751 to Romer and Johnson discloses a reusable berm with a retractable screen at the berm's peak where a disposable pad is inserted; however, this system leads to potential berm cleaning and manual transfer of a saturated pad for disposal opening up the potential for soiling of clothing, flooring and skin.

Now it is proposed to provide a disposable device designed for catching fluid drippings from a motor vehicle. The device is lightweight, economical to manufacture and requires no user assembly. The device requires no cleaning an no manual replacement of the fluid binding materials.

### SUMMARY OF THE INVENTION

A disposable device configured to bind unwanted fluids is taught. The disposable device is comprised of a basin which holds a first layer and a second absorbent layer, enclosed by a perforated sheet. The basin has a base and at least one upwardly emanating side. The perforated sheet is attached to the side. The first layer can be an absorbent material, an adhesive material or a combination thereof. Both the perforated sheet and the basin can be made of a rigid or semi-rigid material. The disposable device is configured to be discarded once the absorbent material is saturated.

### DRAWINGS

FIG. 1 is a perspective view illustrating placement of the disposable device under a vehicle.

FIG. 2 is a perspective view of the disposable device.

FIG. 3 is a cross-sectional view of a preferred form of the disposable device taken about line 3-3 of FIG. 4.

FIG. 4 is a top view of the disposable device showing the removable cover layer retracted to expose the perforations.

FIG. 5 is an exploded view of the components of a preferred form of the disposable device.

FIG. 6 is a cross-sectional view taken through a portion of an alternate form of the disposable device.

### DESCRIPTION OF THE INVENTION

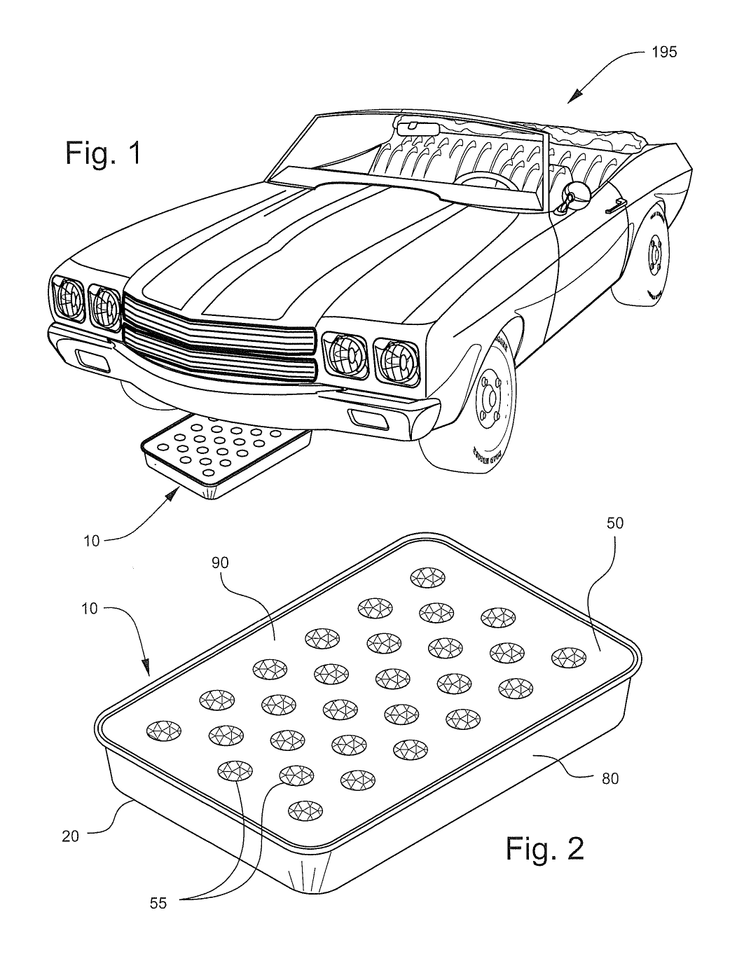

Referring now to FIG. 1, the new disposable device to bind unwanted fluids 10 is shown. The disposable device 10 is intended to be placed on the ground underneath the engine, or any other leaking point, of a motor vehicle 195, such as an automobile. The disposable device 10 may be used to bind unwanted fluids under any liquid or oil retaining motors such as generators, compressors, busses, trucks, construction equipment or industrial hydraulic machinery. While in one embodiment of the disposable device 10 is illustrated in FIG. 2 as a rectangle, it will be understood that the shape of the present invention may be any shape so long as at the embodiment includes a basin 20 with at least one upwardly emanating side 80. The upwardly emanating side 80 may be one continuous side as in the case of a circle or numerous sides as in the case of an octagon. Potential shapes of basin 20 include, but are not limited to a circle, oval, square, rectangle, pentagon, hexagon, heptagon, octagon, nonagon, decagon, polygon, parallelogram, trapezoid, rhombus or any combination thereof. The basin 20 may be constructed of any rigid or semi rigid material including, but not limited to aluminum, cardboard, fiberboard, plastic, composite, paper, metal, fiberglass or any combination thereof. For the purposes of this application the term rigid is defined as incapable of or resistant to bending; stiff or unyielding; not pliant or flexible; hard. For the purposes of this application, the term semi-rigid is defined as not fully rigid and partially flexible.

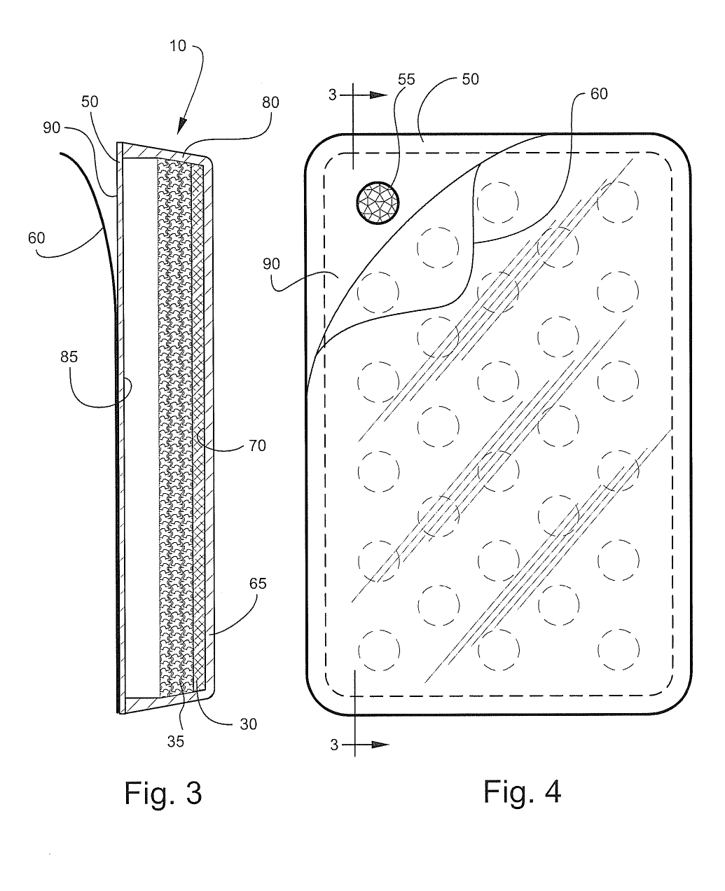

As illustrated in FIG. 2, the disposable device 10 utilizes a perforated sheet 50 attached to upwardly emanating side 80 to create a complete seal. FIG. 3 depicts perforated sheet 50, which has an inner surface 85 and an outer surface 90, as secured to the top of upwardly emanating side 80, along the outside edge of the inner surface 185. The perforated sheet 50 may be constructed of any rigid or semi rigid material including, but not limited to aluminum, cardboard, fiberboard, plastic, composite, paper, metal, fiberglass or any combination thereof. The perforated sheet 50 may also be constructed of any material which is flexible including, but not limited to aluminum, copper, bronze, brass, stainless steel, galvanized steel, plastic, composite, paper, wax paper, metal, fiberglass, nylon, polyester or any combination thereof. Additionally, FIG. 3 illustrates the relationship between the base 65 of the disposable device 10 and the upwardly emanating side 80. The method for attaching perforated sheet 50 to upwardly emanating side 80 may be by any reasonable means including, but not limited to welding, glue, epoxies, fixatives, contact adhesives, high tack multi-purpose glue, liquid cements, mechanical fasteners such as tacks, nails, screws, bolts, rivets or any combination thereof. While FIG. 2 displays perforated sheet 50 resting on top of upwardly emanating side 80, it will be understood that other means of attaching perforated sheet 50 to upwardly emanating side 80 may be used without departing from the scope of this invention. Such means include the perforated sheet 50 being a further extension of the upwardly emanating side 80, folded down at an angle and bonded to the remaining non-bonded portion of the upwardly emanating side 80. In one embodiment of the invention the perforated sheet 50 is attached to the upwardly emanating side 80 so that it is substantially concave inward toward the upper surface 70 of base 65. Additionally, FIG. 2 illustrates the perforations 55 contained within the perforated sheet 50. The perforations 55 may be any shape and may range in size. The size can range from extremely small to large. The perforations 55 may be incorporated into the perforated sheet 50 randomly or in a predetermined pattern. In one embodiment of the invention the perforated sheet 50 is a screen which freely allows the fluids to pass through while retaining the absorbent layers inside of the basin 20. The screen may be rigid, semi-rigid or flexible. The screen may be fabricated into a mesh from any of the following materials including, but not limited to fiberglass, nylon, polyester or any other synthetic fibers; copper, aluminum, bronze, brass, stainless steel, galvanized steel or any other metal wire.

FIG. 3 depicts a cross section of the disposable device 10 illustrating the first layer 30 and second layer 35. First layer 30 is disposed on the upper surface 70 of base 65 and may consist of either an adhesive material or an absorptive material. Second layer 35 generally consists of an absorptive material. If first layer 30 is an adhesive material, it may consist of epoxies, fixatives, contact adhesives, high tack multi-purpose glue, liquid cements or combinations thereof. The preceding list is not exclusive as those familiar with the art will know additional means of bonding two surfaces together. Possible absorptive materials for first layer 30 and second layer 35 include, but are not limited to multiple layers of a woven, a non-woven, or a combination of woven and non-woven materials made up of natural fibers, synthetic fibers, or any combination thereof; natural sponges, synthetic sponges, super absorbent fibers, non-fibrous hydrophilic padding, clay granules, kaolin, fullers earth, attapulgite, processed paper, silica, cardboard, sawdust, kitty litter, dog litter or any combination thereof. In one embodiment of the present invention, to facilitate the binding of unwanted fluids dripping from a motor vehicle or motor, the first layer 30 consists of multiple layers of a woven, a non-woven, or a combination of woven and non-woven materials made up of natural fibers, synthetic fibers, or any combination thereof; natural sponges, synthetic sponges, super absorbent fibers, non-fibrous hydrophilic padding or any combination thereof and the second layer 35 consists of clay granules, kaolin, fullers earth, attapulgite, processed paper, silica, cardboard, sawdust, kitty litter, dog litter or any combination thereof.

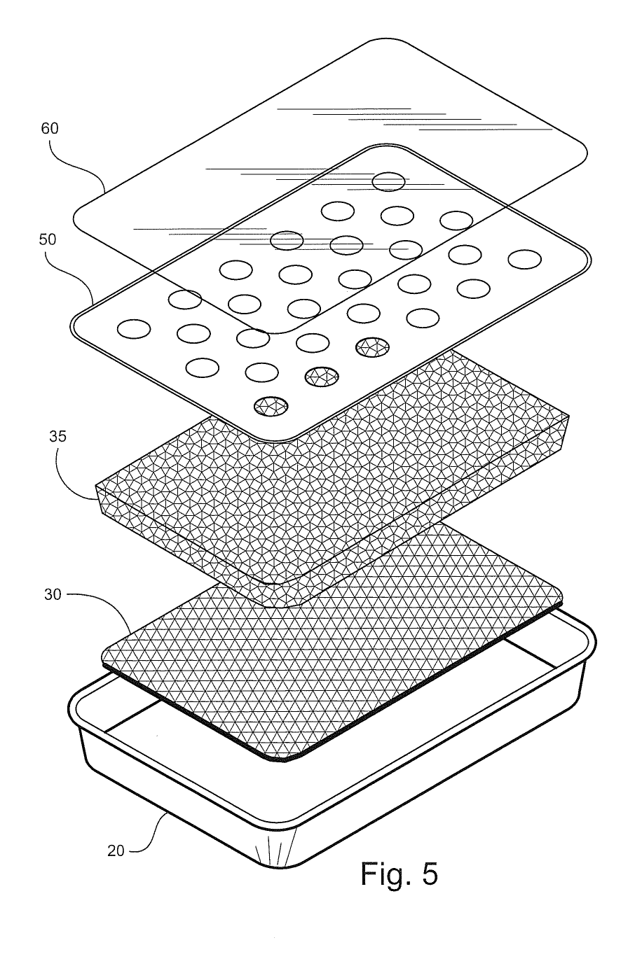

Referring now to FIG. 5 thereof, one embodiment is illustrated wherein the first layer 30 is placed inside the basin 20, followed by the second layer 35 after which the perforated layer 50 is attached to the upwardly emanating side 80 by any of the previously described methods. A removable and, in one embodiment, a reusable cover layer 60 is secured to the outer surface 90 of the perforated sheet 50. The cover layer 60 may be constructed of any rigid or semi rigid material including, but not limited to aluminum, cardboard, fiberboard, plastic, composite, paper, metal, fiberglass or any combination thereof. The cover layer 60 may also be constructed of any material which is flexible including, but not limited to aluminum, copper, bronze, brass, stainless steel, galvanized steel, plastic, composite, paper, wax paper, metal, fiberglass, nylon, polyester or any combination thereof. For the purposes of this application the term flexible means capable of being bent or flexed repeatedly without injury or damage; pliable. The cover layer 60 may be transparent or non-transparent or any combination thereof. In one embodiment the cover layer 60 may be impervious to both organic and inorganic fluids. In another embodiment the cover layer 60 is coated with a reusable adhesive material on one side such as rubber cement. In yet another embodiment the cover layer 60 is comprised of a flexible plastic which bears no adhesive and attaches to the perforated sheet 50 by means of static electricity. In yet another embodiment the cover layer 60 consists of a rigid or semi-rigid material secured to the perforated layer 50 or the upwardly emanating sides 80 by mechanical fasteners such as tacks, nails, screws, bolts, rivets or any combination thereof. The cover layer 60 functions to seal the perforations 55 of the perforated layer 50 of the disposable device 10. In one embodiment the cover layer 60 may function to keep the first layer 30 and second layer 35 from coming out of the basin 20 during transport. FIG. 4 depicts a portion of the cover layer 60 peeled back to reveal the open perforations 55 through the perforated sheet 50.

When a person is ready to use the disposable device 10 they simply remove the cover layer 60 from the outer surface 90 of the perforated sheet 50. The disposable device 10 is then placed underneath a motor vehicle 195 at the location of the dripping of unwanted fluids. When the absorbent layers of the disposable device 10 are saturated with fluids, the user simply re-attaches the cover layer 60 to the outer surface 90 of the perforated sheet 50. The cover layer 60 then effectively seals the unwanted fluids inside the basin 20 allowing for quick, easy, soil free discarding of the disposable device 10.

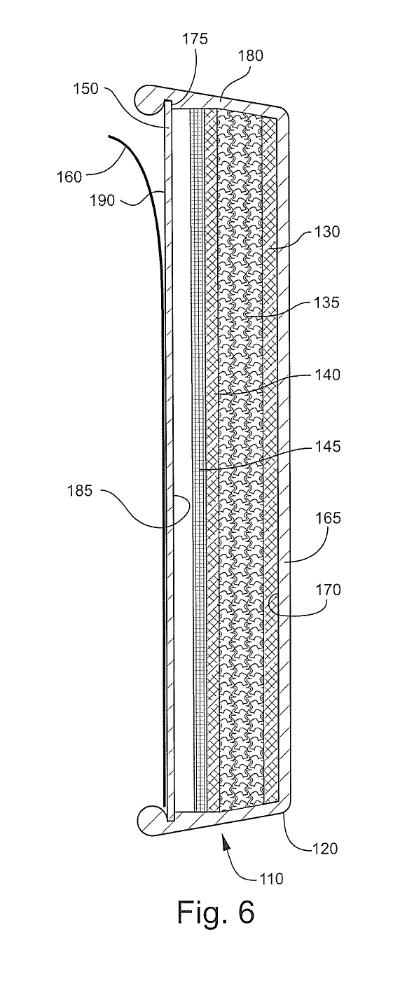

FIG. 6 illustrates an alternative embodiment of the present invention. The disposable device is designated as number 110. The basin 120 is made up of a base 165 with at least one upwardly emanating side 180. Near the top of the upwardly emanating side 180 is a shoulder 175 emanating inward from the upwardly emanating side 180 which is substantially parallel to the upper surface 170 of the base 165. The perforated sheet 150, which has an inner surface 185 and an outer surface 190, is secured to the shoulder 175, along the outside edge of the inner surface 185. Four layers of material reside within the basin 120. First layer 130 consists of an adhesive material and is disposed on the upper surface 170 of base 165. Second layer 135 consists of an absorptive material secured to the first layer 130. Third layer 140 consists of an adhesive material and is disposed on top of second layer 135. Fourth layer 145 consists of an absorptive material secured to the third layer 140. The first layer 130 and the third layer 140 may consist of epoxies, fixatives, contact adhesives, high tack multi-purpose glue, liquid cements or combinations thereof. Possible absorptive materials for second layer 135 and fourth layer 145 include, but are not limited to: multiple layers of a woven, a non-woven, or a combination of woven and non-woven materials made up of natural fibers, synthetic fibers, or any combination thereof; natural sponges, synthetic sponges, super absorbent fibers, non-fibrous hydrophilic padding, clay granules, kaolin, fullers earth, attapulgite, processed paper, silica, cardboard, sawdust, kitty litter, dog litter or any combination thereof. In one embodiment a removable and reusable cover layer 160 is coated with a reusable adhesive material, such as rubber cement, on one side and the coated side is secured to the outer surface 190 of the perforated sheet 150. In another embodiment the disposable device 110 lacks cover layer 160.

What is claimed is:

1. A disposable device to bind unwanted fluids comprising:
a basin comprising a base and a side where said side is at least one upwardly emanating side, said base having an upper surface;
a first layer contained within said basin disposed on said upper surface of said base, said first layer is selected from the group consisting essentially of an absorbent material, an adhesive material or a combination thereof;
a second layer being an absorbent material disposed on top of said first layer;
a perforated sheet secured to said side, said perforated sheet having an inner surface and an outer surface;
where said perforated sheet is made from a material selected from the group consisting of: a rigid material, a semi-rigid material or a flexible material;
where said basin is made from a rigid or semi-rigid material; and
where said disposable device is configured to be discarded once the absorbent material is saturated.

2. The disposable device to bind unwanted fluids according to claim 1 further comprising a disposable, removable cover layer secured to said outer surface of said perforated sheet.

3. The disposable device to bind unwanted fluids according to claim 1 further comprising a reusable, removable cover layer secured to said outer surface of said perforated sheet.

4. The disposable device to bind unwanted fluids according to claim 1 wherein said absorbent material is selected from the group consisting of: multiple layers of a woven, a non-woven, or a combination of woven and non-woven materials made up of natural fibers, synthetic fibers, or any combination thereof; natural sponges, synthetic sponges, super absorbent fibers, non-fibrous hydrophilic padding, clay granules, kaolin, fullers earth, attapulgite, processed paper, silica, cardboard, sawdust, kitty litter, dog litter or any combination thereof.

5. The disposable device to bind unwanted fluids according to claim 1 wherein said first layer is an absorbent material selected from the group consisting of: multiple layers of a woven, a non-woven, or a combination of woven and non-woven materials made up of natural fibers, synthetic fibers, or any combination thereof; natural sponges, synthetic sponges, super absorbent fibers, non-fibrous hydrophilic padding, clay granules, kaolin, fullers earth, attapulgite, processed paper, silica, cardboard, sawdust, kitty litter, dog litter or any combination thereof.

6. The disposable device to bind unwanted fluids according to claim 1 wherein said first layer is an adhesive material selected from the group consisting of: epoxies, fixatives, contact adhesives, high tack multi-purpose glue, liquid cements or combinations thereof.

7. The disposable device to bind unwanted fluids according to claim 1 wherein said basin is made of a material selected from the group consisting of: aluminum, cardboard, fiberboard, plastic, composite, paper, metal, fiberglass or any combination thereof.

8. The disposable device to bind unwanted fluids according to claim 1 wherein said basin has a shape, said shape being selected from the group consisting of: circle, oval, square, rectangle, pentagon, hexagon, heptagon, octagon, nonagon, decagon, polygon, parallelogram, trapezoid, rhombus or any combination thereof.

9. The disposable device to bind unwanted fluids according to claim 1 wherein said first layer is an absorbent material selected from the group consisting of: multiple layers of a woven, a non-woven, or a combination of woven and non-woven materials made up of natural fibers, synthetic fibers, or any combination thereof; natural sponges, synthetic sponges, super absorbent fibers, non-fibrous hydrophilic padding or any combination thereof; and said second layer is an absorbent material selected from the group consisting of: clay granules, kaolin, fullers earth, attapulgite, processed paper, silica, cardboard, sawdust, kitty litter, dog litter or any combination thereof.

10. The disposable device to bind unwanted fluids according to claim 9 further comprising a reusable, removable cover layer secured to said outer surface of said perforated sheet.

11. The disposable device to bind unwanted fluids according to claim 9 wherein said basin has a shape, said shape being selected from the group consisting of: circle, oval, square, rectangle, pentagon, hexagon, heptagon, octagon, nonagon, decagon, polygon, parallelogram, trapezoid, rhombus or any combination thereof.

12. The disposable device to bind unwanted fluids according to claim 9 wherein said basin is made of a material selected from the group consisting of: aluminum, cardboard, fiberboard, plastic, composite, paper, metal, fiberglass or any combination thereof.

13. A disposable device to bind unwanted fluids comprising:
a basin comprising a base and a side where said side is at least one upwardly emanating side, said base having an upper surface;
a shoulder emanating inward from said side which is substantially parallel to said upper surface;
a first layer contained within said basin disposed on said upper surface of said base, said first layer is selected from the group consisting essentially of an absorbent material, an adhesive material or a combination thereof;
a second layer being an absorbent material disposed on top of said first layer;
where said absorbent material is selected from the group consisting of: multiple layers of a woven, a non-woven, or a combination of woven and non-woven materials made up of natural fibers, synthetic fibers, or any combination thereof; natural sponges, synthetic sponges, super absorbent fibers, non-fibrous hydrophilic padding, clay granules, kaolin, fullers earth, attapulgite, processed paper, silica, cardboard, sawdust, kitty litter, dog litter or any combination thereof;
a perforated sheet secured to said side, said perforated sheet having an inner surface and an outer surface;
where said perforated sheet is made from a material selected from the group consisting of: a rigid material, a semi-rigid material or a flexible material;
a reusable, removable cover layer secured to the outer surface of said perforated sheet;
where said basin is made from a rigid or semi-rigid material; and
where said disposable device is configured to be discarded once the absorbent material is saturated.

14. The disposable device to bind unwanted fluids according to claim 13 wherein said basin is made of a material selected from the group consisting of: aluminum, cardboard, fiberboard, plastic, composite, paper, metal, fiberglass or any combination thereof.

15. The disposable device to bind unwanted fluids according to claim 13 wherein said basin has a shape, said shape being selected from the group consisting of: circle, oval, square, rectangle, pentagon, hexagon, heptagon, octagon, nonagon, decagon, polygon, parallelogram, trapezoid, rhombus or any combination thereof.

16. A disposable device to bind unwanted fluids comprising:
a basin comprising a base and at least one upwardly emanating side, said base having an upper surface;
a shoulder emanating inward from said upwardly emanating side which is substantially parallel to said upper surface;
a first layer being an adhesive material contained within said basin disposed on said upper surface of said base;
a second layer being an absorbent material disposed on top of said first layer;
a third layer being an adhesive material disposed on the surface of said second layer;
a fourth layer being an absorbent material disposed on top of said third layer;
a perforated sheet secured to said shoulder, said perforated sheet having an inner surface and an outer surface;
where said perforated sheet is made from a material selected from the group consisting of: a rigid material, a semi-rigid material or a flexible material;
where said perforated sheet is made from a material selected from the group consisting of aluminum, copper, bronze, brass, stainless steel, galvanized steel, cardboard, fiberboard, plastic, composite, paper, wax paper, metal, fiberglass, nylon, polyester or any combination thereof;
a reusable, removable cover layer secured to the outer surface of said perforated sheet;
where said basin is made from a rigid or semi-rigid material; and
where said disposable device is configured to be discarded once the absorbent material is saturated.

17. The disposable device to bind unwanted fluids according to claim 16 wherein said second layer and said fourth layer is an absorbent material selected from the group consisting of: multiple layers of a woven, a non-woven, or a combination of woven and non-woven materials made up of natural fibers, synthetic fibers, or any combination thereof; natural sponges, synthetic sponges, super absorbent fibers, non-fibrous hydrophilic padding, clay granules, kaolin, fullers earth, attapulgite, processed paper, silica, cardboard, sawdust, kitty litter, dog litter or any combination thereof.

18. The disposable device to bind unwanted fluids according to claim 16 wherein said first layer and said third layer is an adhesive material selected from the group consisting of: epoxies, fixatives, contact adhesives, high tack multi-purpose glue, liquid cements or any combination thereof.

19. The disposable device to bind unwanted fluids according to claim 16 wherein said basin is made of a material selected from the group consisting of: aluminum, cardboard, fiberboard, plastic, composite, paper, metal, fiberglass or any combination thereof.

20. The disposable device to bind unwanted fluids according to claim 16 wherein said basin has a shape, said shape being selected from the group consisting of: circle, oval, square, rectangle, pentagon, hexagon, heptagon, octagon, nonagon, decagon, polygon, parallelogram, trapezoid, rhombus or any combination thereof.
